(19) United States
(12) Patent Application Publication
(10) Pub. No.: US 2013/0262661 A1
(43) Pub. Date: Oct. 3, 2013

(54) SOLVING UNDER-DETERMINED PROBLEMS FOR NETWORKS

(71) Applicants: Mehdi Malboubi, Richmond, CA (US); Chen-Nee Chuah, Davis, CA (US); Puneet Sharma, Palo Alto, CA (US)

(72) Inventors: Mehdi Malboubi, Richmond, CA (US); Chen-Nee Chuah, Davis, CA (US); Puneet Sharma, Palo Alto, CA (US)

(21) Appl. No.: 13/438,493

(22) Filed: Apr. 3, 2012

(51) Int. Cl. G06F 15/173

(52) U.S. Cl. 709/224

(57) ABSTRACT

There is provided a computer-implemented method of solving an under-determined problem. The method includes partitioning the under-determined problem into a plurality of sub-problems of reduced order. The method also includes receiving a plurality of local solutions to the plurality of sub-problems. Additionally, the method includes fusing the local solutions to generate a global solution to the under-determined problem.

### BACKGROUND

Various network measurement and inference problems can be posed as under-determined systems of equations. In undetermined systems, the number of unknowns in the system exceeds the number of equations that constrain the system. Because network inference problems belong to the general category of problems called inverse problems that are used to estimate and/or infer information about the network from observed measurements. Such inverse problems are known to be often ill-posed given that there are no unique solutions, or, the problems are sensitive to changes in observed data. One example of an under-determined problem for networks is traffic matrix estimation problem. A traffic matrix represents a measure of traffic entering a network from any ingress point and destined to any egress point. Traffic matrices provide useful information for network design, capacity planning, traffic engineering, and the like. Traffic matrices can be estimated at different levels of granularity in a network: between Points-of-Presence (PoPs), routers, links, and IP prefixes. Finer grained traffic matrices provide more insight about the behavior of the network which can be used in different applications. As such, traffic matrices are typically measured or estimated at the router-to-router level.

However, measuring and estimating traffic matrices are both challenging problems. Direct traffic measurement imposes significant costs, including measurement equipment, processing costs, and communication and storage overheads, for the monitoring of the network. Additionally, measurement systems can fail if they use an unreliable transport protocol. Further, legacy network components may not support the flow collection that measurement systems use. Additionally, many networks lack adequate resources for making the implementation of a measurement system impractical.

### BRIEF DESCRIPTION OF THE DRAWINGS

Certain exemplary embodiments are described in the following detailed description and in reference to the drawings, in which:

FIG. 1 is a block diagram of an example network, in accordance with embodiments;

FIG. 2 is a diagram of an example system for traffic matrix estimation, in accordance with embodiments;

FIG. 3 is a process flow chart of a method for traffic matrix estimation, in accordance with embodiments;

FIG. 4A is a block diagram of a system for traffic matrix estimation, in accordance with embodiments;

FIG. 4B is a block diagram of a system for traffic matrix estimation, in accordance with embodiments;

FIG. 5 is a diagram representing multiple description fusion, in accordance with embodiments;

FIG. 6 is a block diagram of a system for solving under-determined linear problems, in accordance with embodiments; and

FIG. 7 is a block diagram showing a tangible, non-transitory, machine-readable medium that stores code adapted to solve under-determined linear problems, in accordance with embodiments.

### DETAILED DESCRIPTION

In a network with N nodes, e.g., routers, there is an N×N matrix, Zₜ, with entries representing origin-destination flows of the network averaged over a snapshot of time, [t, t+Δt]. Origin-destination flows represent a flow of data traffic between an origin node and a destination node. Each entry in the matrix, Zₜ, represents the volume of network traffic (in bytes, packets, or flows) from an origin node, i, to a destination node, j, over a time interval, [t, t+Δt]. In other words, the columns of snapshot Zₜ form an n=N×(N−1) vector, Xₜ={x^{t}ₖ}kⁿₖ₌₁. The vector, Xₜ, is referred to herein as the traffic matrix.

The traffic matrix is related to a link load measurement vector Yₜ={yᵢ^{t}}ᵢ₌₁^{m} by Equation 1:

Yₜ=HXₜ, (1)

where H is a routing matrix that indicates which links are used by which routes. The structure of the routing matrix depends on the topology of the network, IGP link weights, and routing techniques where the shortest path between each pair of nodes is computed. IGP link weights represent the cost of using particular communication links to forward traffic in a network.

In the routing matrix, rows may represent the links of the network. The columns may represent the origin-destination pairs. The routing matrix, H, may be a sparse matrix of ones and zeros. For example. an element of H, hᵢⱼ will have a value of one, if link, i, belongs to the path associated to origin-destination pair j; otherwise, hᵢⱼ will have a value of zero. The entries of H may have fractional values if the network supports traffic splitting.

Equation 1 is an under-determined and ill-posed, linear system of equations because the number of nodes is typically much smaller than the number of origin-destination flows. Accordingly, traffic matrix estimation is an under-determined and ill-posed linear inverse problem. In embodiments, under-determined problems, such as traffic matrix estimation, are partitioned into several smaller, simpler sub-problems. Each of these sub-problems is solved to generate multiple descriptions of the traffic matrix estimation problem. Solutions to traffic matrix estimation can be based on side information, which is prior or current knowledge about the traffic matrix estimation problem. In embodiments, side information is provided by the multiple descriptions of the traffic matrix. These multiple descriptions are fused together to provide a more accurate traffic matrix estimate than typical approaches.

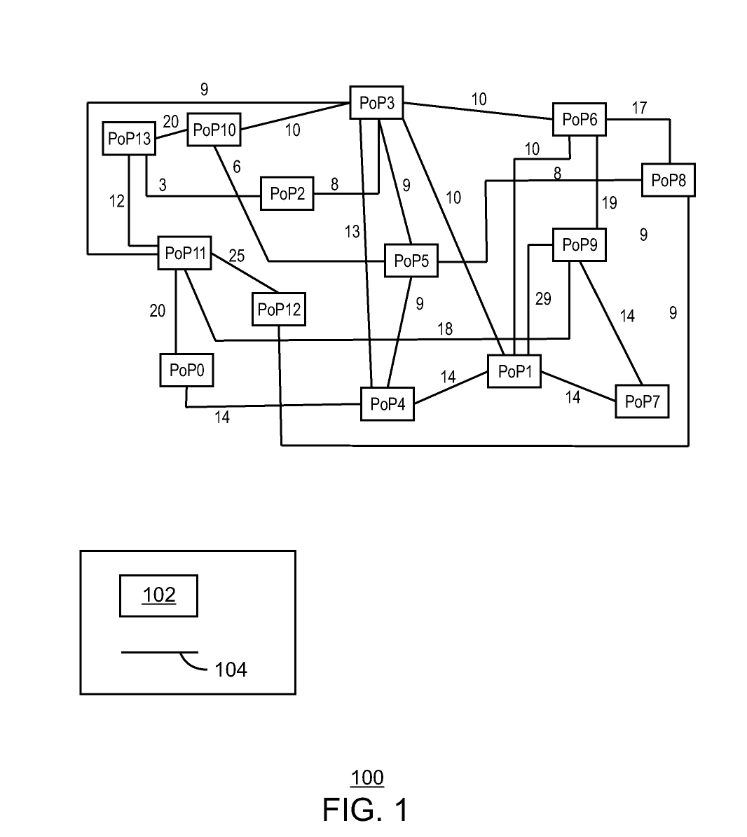

FIG. 1 is a block diagram of an example network 100, in accordance with embodiments. The network includes nodes 102 and links 104. The nodes 102 may be points of presence (PoPs), routers, and the like. An origin-destination flow between two nodes 102 occurs over one or more links 104. For instance, link state routing protocols, such as, Intermediate System to Intermediate System (IS-IS) may be used for route computation. In such a case, each of the links is labeled with an ISIS link weight. The ISIS link weight represents the cost of forwarding traffic over a particular link in a network, which can be a static metric (e.g., inversely proportional to its capacity) or dynamic metric (e.g., proportional to congestion level).

The routing matrix, H, for the network 100 may be based on ISIS link weights and the Dijkstra Algorithm. The Dijkstra Algorithm is a graph search algorithm for solving a single-source shortest path problem in a graph with non-negative edge path costs.

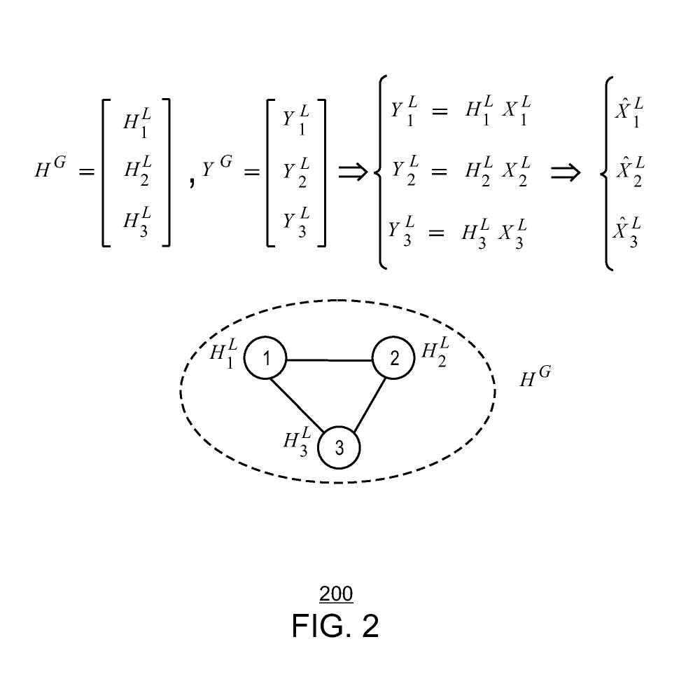

FIG. 2 is a diagram of an example system 200 for traffic matrix estimation, in accordance with embodiments. In the system 200, the routing matrix H is partitioned into several decoupled sub-matrices, H₁₋₃^{L}, providing different, e.g., local, perspectives of the traffic matrix, X. As shown, given a global routing matrix, H^{G}, local solutions for X may be derived by solving each sub-problem.

Embodiments use various deterministic and probabilistic methods for solving each sub-problem. For example, one deterministic approach minimizes the Least Square Error using singular value decomposition (SVD). The local solutions are fused. In other words, a fusion function, e.g., f([X^{L}]), shown in FIG. 2, generates a singular solution from the multiple local solutions, \hat{X}^{L1}, \hat{X}^{L2}, and \hat{X}^{L3}. The fusion function is configured to mathematically maximize for accurate traffic matrix estimation. Averaging is one example of a fusion function. Averages may be derived, for example, over observed origin-destination flow in a sub-space. Alternatively, the fusion function may select a sub-space based on inverse condition number (ICN) or rank over origin-destination flow (ROD). The inverse conditional number is the inverse of the conditional number of the routing matrix of the sub-space. The ROD represents a sub-space rank divided by the number of origin-destination flows observed by that sub-space. The traffic matrix, X, may be generated with different probability distributions such as Uniform, Normal, and Poisson distributions.

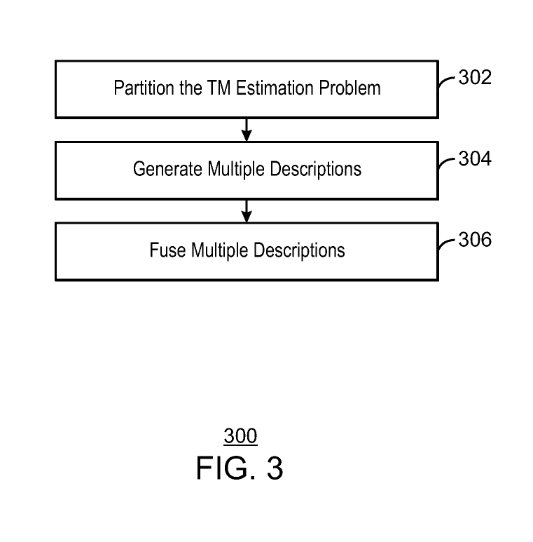

FIG. 3 is a process flow chart of a method 300 for traffic matrix estimation, in accordance with embodiments. It should be understood that the process flow diagram is not intended to indicate a particular order of execution. The method 300 begins at block 302, where the under-determined problem, i.e., Equation 1, is partitioned into several sub-problems. Partitioning the traffic matrix estimation problem reduces the problem complexity, thereby reducing the processing time for solving the traffic matrix estimation. At block 304, these sub-problems are independently solved in their respective sub-spaces to produce multiple descriptions of the traffic matrix. The multiple descriptions represent intermediate estimates in specific sub-spaces of the same traffic matrix. These multiple sub-space solutions may be determined in parallel, or sequentially.

By dividing a large under-determined linear system of equations, e.g., Equation 1, into independent sub-problems, multiple local views (containing partial entries of the traffic matrix) are generated. These local views are more coherent and may be more informative than the global estimate. Each sub-space produces a more coherent, informative description of the partial traffic matrix, resulting in a more precise estimation of the subset of traffic matrix entries. The accuracy of traffic matrix estimations may also depend on the partitioning and fusion techniques used. Embodiments may merely use link count data to partition and fuse, and not auxiliary measurements, such as SNMP data or NetFlow records. Simple Network Management Protocol (SNMP) is a protocol for managing devices on IP networks. NetFlow records provide a wide variety of information about the traffic in a given flow through the direct observation of the network traffic. Note that, in both centralized and distributed cases, if these auxiliary information are available they can be used to improve the performance of traffic matrix estimation.

By solving these sub-problems in independent sub-spaces (using existing traffic matrix estimation techniques), multiple descriptions of the same traffic matrix, Xₜ, are produced. These descriptions, which are considered as side information for each other, can be weighted to increase or diminish their contribution to the traffic matrix estimation, depending on the partitioning technique.

At block 306, these descriptions can be fused to enhance the accuracy of traffic matrix estimation. The multiple descriptions can be fused together to solve the original Equation 1, and provide a global view with better accuracy than current techniques. The accuracy depends on the partitioning technique and weights for fusion function used in fusing the multiple descriptions. This method 300 also decreases the computational overhead, enhancing the system's robustness against noise and failures.

The method 300 may be implemented using different data fusion structures depending on where the data is collected, how or where the estimation is performed, and how or where the fusion takes place. In embodiments described herein, traffic matrix estimation may be performed in centralized or distributed manner, depending on the location of the monitors and fusion centers. Embodiments include various algorithms for partitioning the original traffic matrix problem into subspaces. In this way, more coherent multiple descriptions can be generated, and fused together, to reduce overall estimation error.

This method provides a flexible and complementary framework that can be coupled with different existing traffic matrix estimation techniques. By intelligently dividing an under-determined linear system of equations into several reduced-order problems, multiple description of the traffic matrix can be estimated. By fusing these local descriptions, the accuracy of traffic matrix is improved, the computation overhead is reduced, and the robustness of the system against noise and failures is enhanced. This is useful for traffic engineering on large, dynamic networks, where traffic matrix entries are estimated at relatively faster time-scales than small, static networks.

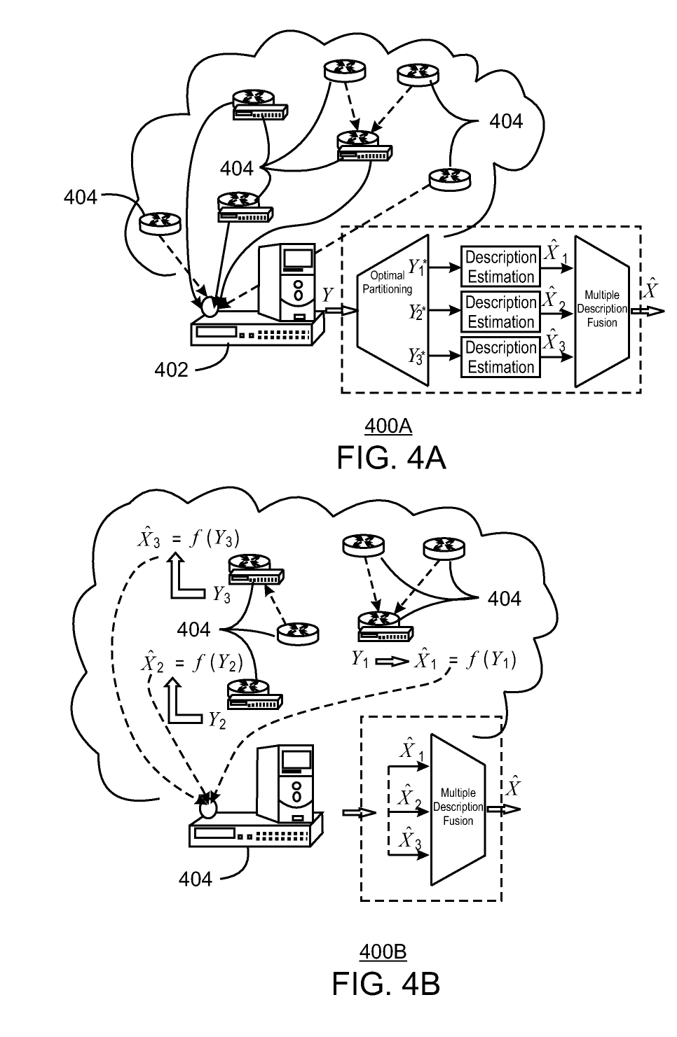

FIG. 4A is a block diagram of a system 400A for traffic matrix estimation, in accordance with embodiments. The system 400A is a centralized system for traffic matrix estimation. The system 400A includes a central fusion center 402 and nodes 404. In the system 400A, all link count measurements are communicated from the nodes 404 to the central fusion center 402, which performs the method 300. The central fusion center 402 partitions the original problem, solves the sub-problems to generate multiple descriptions of traffic matrix, and then fuses the results together to estimate the complete/global traffic matrix.

FIG. 4B is a block diagram of a system 400B for traffic matrix estimation, in accordance with embodiments. The system 400B is a distributed system for traffic matrix estimation. In the system 400B, the local monitors on the nodes 404 gather local link load measurements to perform local estimates of a subset of traffic matrix entries. The local estimates are also referred to herein as local descriptions and local solutions. These local descriptions are transmitted to the central fusion center 402 for fusion to obtain the global estimate of the traffic matrix.

In an embodiment of a system with a decentralized structure (not shown), local monitors on nodes gather a sub-set of the link load measurements (forming sub-spaces), and generate descriptions of the local traffic matrix. These local monitors communicate their local descriptions with one another, which are then combined, at each node, to form a global view of the traffic matrix locally. In embodiments with a decentralized structure, the system may not include the central fusion center 402.

Embodiments also include a heuristic approach for distributed traffic matrix estimation to determine how link counts can be clustered for solving traffic matrix estimation sub-problems at local monitors. Embodiments not only decrease the computational overhead, but enhance robustness against failures in communication networks and monitoring infrastructure.

In an example implementation, traffic matrix estimation error was reduced more than 20% while processing time was reduced by more than 90%. The performance of traffic matrix estimation is also enhanced against noise in link load measurements and sub-space erasure. In this way, embodiments are robust to failures and errors in the network measurement system. This is also true for large-scale networks, e.g., large IP backbone, distributed traffic matrix estimation, distributed data centers, or a cloud environment, where traffic engineering may be performed at much smaller time-scales. Embodiments may also be used to solve other under-determined linear systems of equations, independent of the specific sub-space's traffic matrix estimation technique. Hence, embodiments provide a flexible framework for partitioning and fusing original problem and a complementary approach that is independent of the estimation used for solving individual partitions. In this way, a variety of traffic matrix estimation methods may be used while solving individual partitions.

Embodiments provide a complementary approach for solving traffic matrix estimation, where it is assumed that an appropriate estimation method is used for local and global traffic matrix estimations, based on the input traffic matrix. For example, the least squares error (LSE) method could be used for solving individual partitions. LSE is sensitive to traffic matrix inputs with unusual origin-destination flows. As such, the least square error method may be used for traffic matrix estimation, globally and locally, if the traffic matrix does not contain unusual origin-destination flows that differ in size by a large order of magnitude.

In the original traffic matrix estimation problem, estimating Xₜ from link load measurements Yₜ, is performed using Equation 1, where Xₜ={x^{t}ₖ}ⁿₖ₌₁, and Yₜ={y^{t}ₖ}k^{m}ₖ₌₁. Here, for simplicity, the subscript, t, is dropped. The least square error solution of this under-determined linear system of equations, i.e., the global estimate, can be computed as shown in Equation 2:

\hat{X}=H†Y=H^{T}(HH^{T})⁻¹Y, (2)

where H† is the pseudoinverse of the routing matrix H defined as H†=H^{T}(HH^{T})⁻¹. The pseudoinverse of H† can be computed more accurately and efficiently using the Singular Value Decomposition (SVD) of H.

The SVD of H is represented as H=UΣV^{T} where U is an m×m unitary matrix, Σ is an m×n rectangular, diagonal matrix with nonnegative-real diagonal entries, i.e., singular values, and V^{T} is an n×n real unitary matrix. Accordingly, H† is computed as H†=VΣ†U^{T} where Σ† is computed by replacing non-zero diagonal entries of Σ00 by its reciprocal and transposing the resulting matrix. The overall cost of the computing of the SVD of an m×n matrix is O(mn²) flops.

Assume that H is known and this problem is partitioned into L sub-problems. Also, let I denote the set of all indices of link counts (that is, I={1, 2, . . . , m} where m is the number of link counts) and Iᵢ denotes the i^{th} set of disjoint indices of link counts where I=Uᵢ₌₁^{L}Iᵢ and Iᵢ= for i≠j. The set P=Uᵢ₌₁^{L}Iᵢ forms a Partition of I where I is divided into multiple non-overlapping and non-empty sub-sets, covering I. Let J denotes the set of all indicies of origin-destination flows (that is, J={1, 2, . . . , n}, where n is the number of origin-destination flows), and Jᵢ denotes the i^{th} set of indices of origin-destination flows where J=Uᵢ₌₁^{L}Jᵢ. However, the intersection of Jᵢ and Jⱼ may not be empty. It is noted that |Iᵢ|≦m and |Jᵢ|≦n for all i=1, . . . , L (|.| denotes the cardinality of the set). Now, let Yᵢ: ={yₖ}_{kεI}_{ᵢ}, Hᵢ: =H(I₁,:) and Xᵢ: ={xₖ}_{kεJ}_{ᵢ}. As such, the i^{th} traffic matrix estimation sub-problem is defined as shown in Equation 3:

Yᵢ=HᵢXᵢ. (3)

The least square error solution of this under-determined sub-problem, i.e., local estimate, is computed using the pseudoinverse of the sub-routing matrix, Hᵢ, as represented in Equation 4:

\hat{X}ᵢ†Yᵢ=Hᵢ^{T}(HᵢHᵢ^{T})⁻¹Yᵢ. (4)

The pseudoinverse Hᵢ† is also computed using the SVD of Hᵢ. Hᵢ is an mᵢ×nᵢ matrix where mᵢ≦m and nᵢ≦n. Therefore, the computation overhead for finding the least square error solution \hat{X}ᵢ is reduced. In fact, the computation cost in each sub-space is O(mᵢnᵢ²) flops; therefore, by solving each sub-problem in parallel, the computation time can be further reduced.

Because each subrouting matrix, Hᵢ, is more compact compared to the global traffic matrix estimation, Equation 4 can provide a more coherent solution in the i^{th} sub-space than could be seen in Equation 2. Further, the condition number of each sub-routing matrix, Hᵢ, is lower than the condition number of routing matrix, H. The condition number represents the ratio of the maximum and minimum singular values of the routing matrix, H, that is,

$$κ = \frac{max ( diag ( \sum ) )}{min ( diag ( \sum ) )} .$$

The condition number indicates how well-behaved is the output in proportion to small changes in the input of the function. Thus, if κᵢ≦κ, then the least square error solution of i^{th} sub-space is more accurate and robust.

The condition numbers of sub-routing matrices, Hᵢ, are reduced in comparison with the condition number of the routing matrix, H. The signal-to-noise ratio of local estimates are higher than the signal-to-noise ratio of the global estimate. In fact, under specific conditions which may be achieved through partitioning, the improvement factor of local sub-spaces is lower than the original global space on average. It is noted that the lower the improvement factor is, the more the signal-to-noise ratio improvement is. Further, the amount of redundancy between descriptions, produced by observing each traffic matrix entries from different sub-spaces, is increased, which leads to generating a better estimate through the fusion process. This redundancy can be evaluated by two measures, that is, the sum of the Number of origin-destination Flows (NoD) observed by different subspaces (Rdn1), and the sum of the ratio

$${RoD}_{i} := \frac{rank ( {H}_{i} )}{{n}_{i}}$$

(Rank over origin-destination flow) which, conceptually, represents the contribution of each independent link count into the estimation of each origin-destination flow, represented in Equation 5:

Rdn1=Σᵢ₌₁^{L}NoDᵢ & Rdn2=Σᵢ₌₁^{L}RoDᵢ (5)

Thus, if Rdn2>RoD (where

$$RoD := \frac{rank ( H )}{n} )$$

embodiments can provide a more accurate traffic matrix estimation. Having estimates, \hat{X}ᵢ, form L sub-spaces, these local views are conformed and fused together to improve the precision of the estimated traffic matrix, \hat{X}^{F}. The conformation and fusion processes are performed by applying appropriate weights to each local estimate, and concatenating the resulting estimates, which is represented by Equation 6:

\hat{X}^{F}⊕ᵢ₌₁^{L}ωᵢ^{F}\hat{X}ᵢ, (6)

where the operator, ⊕, denotes the fusion process of the partitioned problem, that is, combining only origin-destination flows observed by different sub-spaces.

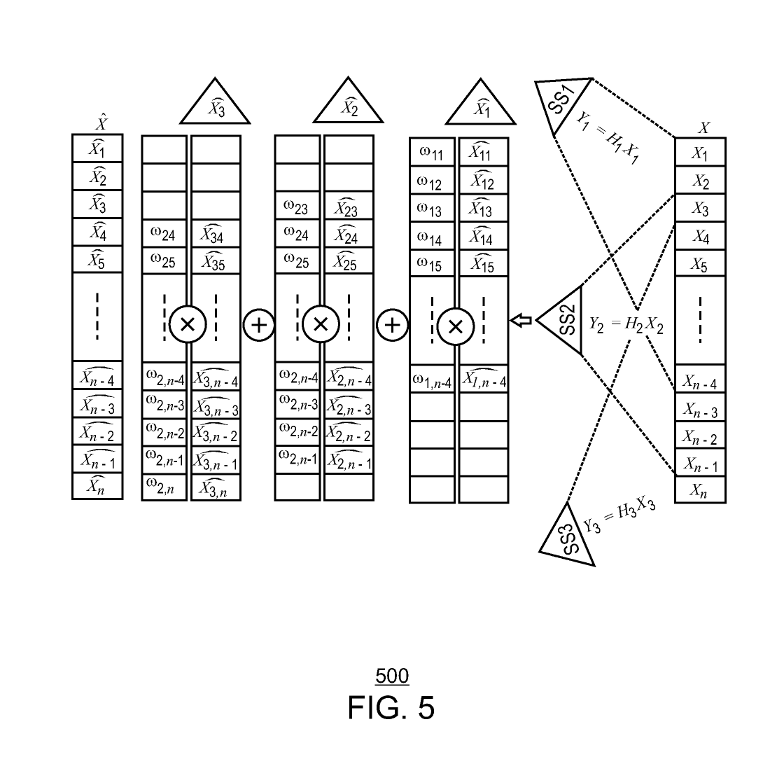

FIG. 5 is a diagram representing multiple description fusion, in accordance with embodiments. The original traffic matrix estimation problem, i.e., Equation 1, is partitioned into three sub-problems. In other words, Yₜ=H Xₜ, is partitioned into Y₁=H₁X₁, Y₂=H₂X₂, and Y₃=H₃X₃. As shown, each sub-problem is solved to estimate three local views of the traffic matrix, \hat{X}ᵢ (i=1, 2, 3). After applying weights to each local estimate, origin-destination flows are fused and added together to construct an estimate of the traffic matrix. Three example weighting functions are represented in equation 7:

$$\begin{matrix}{ω}_{ij}^{ICN} = ( \begin{matrix}1 , & for i belongs to the sub - space with highest ICN and j ∈ {J}_{i} \\ 0 , & otherwise\end{matrix} & ( 7 ) \\ {ω}_{ij}^{RoD} = ( \begin{matrix}1 , & for i belongs to the sub - space with highest RoD and j ∈ {J}_{i} \\ 0 , & otherwise\end{matrix} & \\ {ω}_{ij}^{Avg} = \frac{1}{\# of repetitions of {X}_{j} in different sub - spaces} & \\ for i = 1 \text{:} L ; & \\ j = 1 \text{:} n , & \end{matrix}$$

By applying a fusion function, origin-destination flows observed in the local sub-spaces are combined to produce the global traffic matrix estimate \hat{X}^{F}. The fusion functions may choose the origin-destination flow, xᵢ, from the sub-space with highest inverse condition number, ICN, or RoD, or compute the average of the observed origin-destination flows by different sub-spaces. The averaging process, by itself, can improve the accuracy of the estimation by increasing the signal to noise ratio. It is noted that these fusion functions are also efficient because the computational overhead of these particular functions is reduced in comparison with the computation time of solving Equations 2 and 4.

The effectiveness of the partitioning technique contributes to the improvement in the performance of the traffic matrix estimation. Further, the design of the partition is an optimization problem that depends on the structure of the traffic matrix estimation. In a centralized implementation, described with reference to FIG. 4A, the partitioning technique aims to achieve an accurate estimate of the traffic matrix using multiple description fusion. On the other hand, in the distributed implementation, described with reference to FIG. 4B, partitioning is used to distribute link load measurements between local nodes so that the traffic matrix estimation gain is mathematically maximized, while the cost of communication is mathematically minimized, and other specified considerations are satisfied. Communication costs may include the communication and delay costs of monitoring the link counts, and distributing the counts and descriptions to the local nodes. In this way, having multiple descriptions from local nodes, the fusion function can be performed locally or globally.

The performance of the traffic matrix estimation in accordance with embodiments is further discussed with respect to an example implementation performing traffic matrix estimation for example network 100. As stated previously with respect to FIG. 1, the network 100 is a Tier-1 POP-level topology, with 14 nodes (N=14), 182 origin-destination flows (n=14×13), and 50 (non-zero) link counts (m=50). The ISIS link weights and Dijikstra algorithm are used to determine the m×n routing matrix, H. Link load counts, Y, are computed using Equation 1, where the traffic matrix entries (or origin-destination flow), xᵢ, are generated with three different distributions: 1) Uniform distribution where xᵢ: U(100,500); 2) Gaussian distribution where xᵢ: [symbol] (μᵢ,40) (where μᵢ: U[100,500]), and 3) Poisson distribution where xᵢ: Pois(λᵢ) where λᵢ: U[100,500].

In an example implementation, this problem was partitioned into L=5 sub-problems as shown in Equation 8:

$$Y = HX ⇔ [ \begin{matrix}{Y}_{1} \\ {Y}_{2} \\ {Y}_{3} \\ {Y}_{4} \\ {Y}_{5} \\ \end{matrix} ] = [ \begin{matrix}{H}_{1} {X}_{1} \\ {H}_{2} {X}_{2} \\ {H}_{3} {X}_{3} \\ {H}_{4} {X}_{4} \\ {H}_{5} {X}_{5} \\ \end{matrix} ] , \qquad ( 8 )$$

where non-overlapping sets {Iᵢ}ᵢ₌₁⁵ are defined as I₁={1, . . . , 7}, I₂={8, . . . , 11}, I₃={12, . . . , 19}, I₄={20, . . . , 37}, I₅={38, . . . , 50}. Table 1 indicates the mapping of the various origin-destination flows and link counts into 5 different sub-spaces, SS1-SS5, as compared to the original, i.e., whole space. In Table 1, the origin-destination relation of link counts in different sub-spaces ((i,O.D) denotes (index, Origin, Destination). Given this partition and the routing matrix, H, the corresponding sets {Jᵢ}ᵢ₌₁^{L} may be determined.

TABLE 1

| SS1 | SS2 | SS3 | SS4 | SS5 |
|---|---|---|---|---|
| (i, O, D) | (i, O, D) | (i, O, D) | (i, O, D) | (i, O, D) |
| (1, 6, 3) | (8, 3, 6) | (12, 13, 2) | (20, 9, 8), | (38, 0, 11), |
| | | | (29, 3, 5) | (45, 3, 1) |
| (2, 1, 3) | (9, 3, 2) | (13, 2, 13) | (21, 9, 7), | (39, 3, 11), |
| | | | (30, 3, 4) | (46, 4, 1) |
| (3, 5, 3) | (10, 9, 6) | (14, 13, 10) | (22, 11, 12), | (40, 13, 11), |
| | | | (31, 3, 10) | (47, 1, 6) |
| (4, 2, 3) | (11, 11, 13) | (15, 10, 13) | (23, 6, 8), | (41, 11, 0), |
| | | | (32, 5, 8) | (48, 8, 6) |
| (5, 4, 3) | | (16, 6, 9) | (24, 8, 12), | (42, 4, 0), |
| | | | (33, 5, 10) | (49, 0, 4) |
| (6, 10, 3) | | (17, 8, 9) | (25, 12, 8), | (43, 7, 1), |
| | | | (34, 5, 4) | (50, 1, 7) |
| (7, 11, 3) | | (18, 7, 9) | (26, 8, 5), | (44, 6, 1) |
| | | | (35, 1, 4) | |
| | | (19, 11, 9) | (27, 4, 5), | |
| | | | (36, 12, 11) | |
| | | | (28, 10, 5), | |
| | | | (37, 9, 11) | |

Table 2 represents characteristics of the original traffic matrix estimation problem for the network 100, and characteristics of the sub-spaces. The inverse condition number, ICN, of each sub-space is higher than the inverse condition number of the original global problem. The total redundancy using this partition is improved, that is, Rdn1=313 which is 313/182=1.72 times of the original problem and Rdn2>RoD. This table also shows that the improvement factor (IF) of each sub-space is less than one, and thus, the signal to noise ratio is improved by partitioning. Therefore, overall, it is expected that embodiments improve the performance using this partition.

TABLE 2

| | Original | | | | | |
|---|---|---|---|---|---|---|
| | Problem | SS1 | SS2 | SS3 | SS4 | SS5 |
| Link Counts | 50 | 7 | 4 | 8 | 18 | 13 |
| ICN | 0.1669 | 0.6124 | 0.2425 | 0.2993 | 0.2664 | 0.3399 |
| Rank | 50 | 7 | 4 | 8 | 18 | 13 |
| # of OD | 182 | 70 | 32 | 43 | 99 | 69 |
| Flows | | | | | | |
| RoD | 0.2747 | 0.1000 | 0.1250 | 0.1860 | 0.1818 | 0.1884 |
| IF | Not- | 0.0700 | 0.0959 | 0.1794 | 0.2689 | 0.1766 |
| | Applicable | | | | | |

Rdn1 = 313, Rdn2 = 0.7812
IF^{Avg} = 0.0.0879

Another advantage of embodiments is the improvement of the robustness of the system against noise in link load measurements, and failures in communication networks and monitoring infrastructure. Noise in link load measurements can be modeled as a White Gaussian Noise (WGN), which is added to link measurement vector Y with different signal to noise ratios. Table 3 shows that embodiments using averaging for a fusion function achieve better improvement in the presence of noise, even at low signal to noise ratios, in comparison to typical approaches for global traffic matrix estimation, such as Equation 2.

TABLE 3

| SNR(dB) | −6 | −3 | 0 | 3 | 6 |
|---|---|---|---|---|---|
| GE | 0.6797 | 0.6668 | 0.6488 | 0.6242 | 0.5928 |
| FE_{Avg} | 0.5823 | 0.5673 | 0.5469 | 0.5212 | 0.4903 |
| Erased Sub-Space | 1 | 2 | 3 | 4 | 5 |
| GE | 0.4295 | 0.4276 | 0.4287 | 0.4861 | 0.4647 |
| FE_{Avg} | 0.4166 | 0.3882 | 0.4078 | 0.5503 | 0.4800 |

Embodiments are robust against failures in the system. However, this robustness depends on the characteristics of sub-space erased from the fusion process. For example, the example network 100 is more sensitive to the erasure of the sub-space with highest rank and largest number of observed origin-destination flows, e.g., sub-space 4 according to Table 2. The robustness against failures can be improved by increasing the number of sub-spaces. Further, in a distributed system, unequal protection strategies can be used to ensure that the descriptions from specific sub-spaces are reported correctly for fusion.

In a centralized embodiment, such as system 400A, link count measurements are communicated to the central fusion center 402, where the multiple descriptions are generated and fused together to estimate the traffic matrix. In such an embodiment, a partition is formed by choosing sub-spaces with the highest value inverse condition numbers. In this inverse condition number based partitioning, the sub-spaces (i.e., {Iᵢ}ᵢ₌₁^{L}) are sequentially chosen to build the partition P=Uᵢ₌₁^{L}Iᵢ with the highest inverse condition number.

Assume there are m link counts and the traffic matrix estimation is partitioned into L sub-problems with K link load measurements (where K∝m/L) in each sub-space. In large-scale networks where L<<m, there is a very large number of different partitiions (M) of the set I={1, . . . , m}; therefore, choosing a partition that provides efficient traffic matrix estimation is a hard problem.

Choosing L, in general, depends on the complexity of traffic matrix estimation technique and the processing gain. An initial estimate for L can be approximated as

$${L}_{0} = ⌈ \frac{{O}^{G}}{{O}_{max}^{L}} ⌉$$

where O^{G} denotes the complexity of global traffic matrix estimation and Oₘₐₓ^{L} is the maximum complexity of traffic matrix estimation in sub-spaces to achieve the desired L₀. By considering the complexity of SVD as O(mn²), L₀ can be obtained by

$${L}_{0} = ⌈ \frac{{mn}^{2}}{( {mn}^{2} ) max} ⌉$$

where (mn²)ₘₐₓ is the maximum complexity of sub-spaces.

In one embodiment, a partition is determined by computing the inverse condition numbers of the possible combinations of rows of H. To partition the traffic matrix, the sub-spaces with highest inverse condition numbers are selected according to Algorithm 1:

```
Initialization: I = {1,...,m} and i = 1
while i ≦ L do
    Construct set Iᵢ (i.e. choose K rows of H out of (_{K}^{|I|}) combinations)
    with highest ICN
    Set I = I\Iᵢ and i = i + 1
end while
```

In one embodiment, a greedy algorithm is used for determining the partition. In such an embodiment, the greedy algorithm starts from the first row of H and sequentially chooses the row that maximizes the inverse condition number of the sub-matrix formed by a partition there. An example greedy algorithm is shown in Algorithm 2:

```
Initialization: I = {1,...,m} and i = 1
While i ≦ L do
    Construct Iᵢ by sequentially choosing K rows of H with highest ICN
    Set I = I\Iᵢ and i = i + 1
end while
```

It is noted that the inverse condition number of each individual row of the routing matrix, H, is one. This continues to complete the first sub-space with K rows. After removing these K rows from the routing matrix, the algorithm repeats from the beginning. This algorithm can be combined by the method described in Algorithm 1 to successively refine the first K₀(K₀≦K) elements of each set (depends on m and K) or by design of the last sets of the partition P using Algorithm 1.

In another embodiment, the design of partition P is based on the QR decomposition of the routing matrix, represented as shown in Equation 9:

H=QR=Q_{m×m}[R_{r×r}¹¹R_{r×(n-r)}^{12]}, (9)

with orthonormal matrix Q, upper-triangular matrix R¹¹ and rank(H)=r(=m). For rank deficient matricies, QR decomposition with pivoting, known as QRP, provides a less expensive method for solving linear system of equations. However, QR decomposition may also be less accurate, such as, in comparison with SVD. QRP is also useful for recognizing singularities or rank deficiency. In QRP, at each step of the factorization process, the column of the unfactored part of the routing matrix with largest norm is used as the basis for that step. Accordingly, HP_{ν} is factorized as HP_{ν}=QR where P_{ν} is a permutation matrix, indicating the pivoting process. This pivoting strategy attempts to produce a well-conditioned R¹¹. Accordingly, the diagonal elements of |R| occur in decreasing order, revealing the linear independence among the rows of the routing matrix. An example QRP algorithm is shown in Algorithm 3:

```
Initialization: Construct P₀ = ∪ᵢ₌₁^{L} Iᵢ where Iᵢ = {(i − 1)K + 1,...,iK}
and set i = 1 while i ≦ L do
    Modify the boundaries of set Iᵢ (by extending or shrinking the
    boundaries of the set)
    Check the performance until the maximum gain is achieved
                              i = i + 1
end while
```

In QRP based partitioning algorithm, as shown in Algorithm 3, the diagonal entries of |R| (occurring in decreasing order) are used to design an initial partition, P₀. For this purpose, a set of diagonal elements of matrix |R| is used to construct a sub-space. Each set includes indicies of K successive diagonal entries of matrix |R|. The partition, P₀, is defined as P₀=Uᵢ₌₁^{L}Iᵢ where Iᵢ for initial partition P₀ can be set as Iᵢ={(i=1)K+1, . . . , iK}. Partition P₀ is modified by extending or shrinking the boundaries of sets {Iᵢ}ᵢ₌₁^{L}, to improve performance.

In one embodiment, the routing matrix H is full row-rank. Therefore, rows corresponding to very small values of diag(|R|) are removed. This scenario typically results when the routing matrix is not sparse. In such a scenario, the structure of the network and routing protocol (represented by the routing matrix) can be used to improve performance via column-wise partitioning. In column-wise partitioning, the cross-correlation between origin-destination flows are used for partitioning.

In a distributed environment, such as system 400B, link measurements are distributed between local nodes, and multiple descriptions of the traffic matrix are computed at local nodes. These local descriptions are communicated to the central fusion center 402 and fused together to create the estimate of the traffic matrix. In this case, producing multiple descriptions is a design problem involving several factors. Among these factors are the communication cost and delay, which impact the design. Communication cost and delay depend on several factors, such as, the bandwidth of links and the distance between nodes. The communication cost and delay represent the cost and delay of transferring all link counts and local descriptions to the local monitors or central fusion center 402. In an example implementation, the nodes with largest degree, i.e., the largest number of edges incident to that node, have less communication cost and delay.

Embodiments may be used to improve the performance of estimation in linear inverse problems in various applications, such as network loss inference, and localization in sensor networks. In these applications, a sensing matrix, H, linearly relates an observation vector, Y, and an unknown vector, X, through an under-determined linear system of equations, e.g., Y=HX (Equation 1, where t is dropped for simplicity).

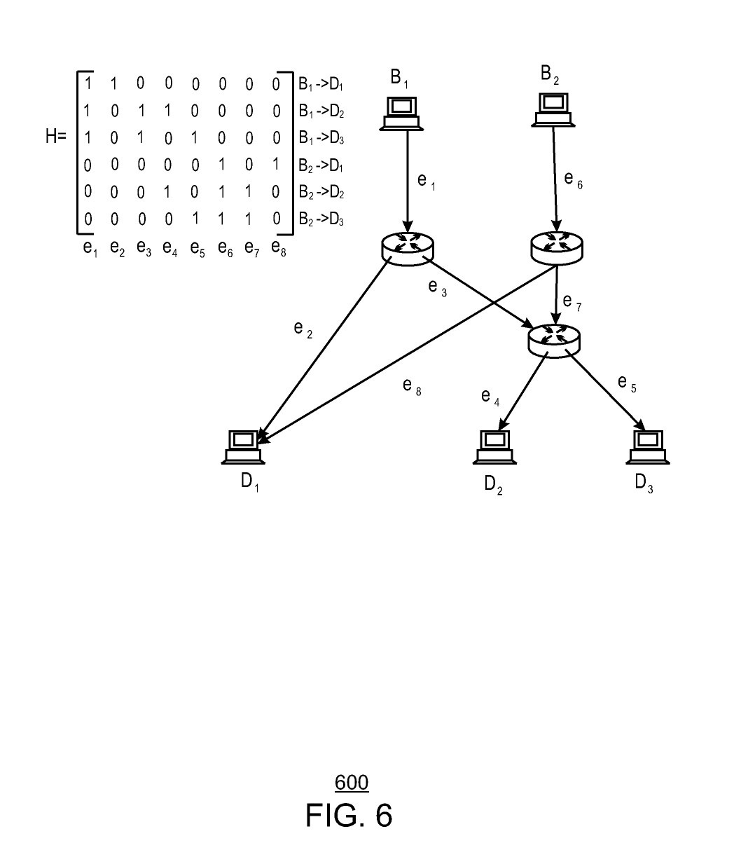

FIG. 6 is an example network 600, in accorance with embodiments. The network 600 includes beacon nodes, B1 and B2, and destination nodes, D1, D2, and D3, connected over directed links, e₁-e₈. The beacon nodes, B1 and B2, send periodic probes with constant inter-arrival times to the destination nodes, D1, D2 and D3. The aggregated routing topology of the network 600 contains 6 end-to-end paths, and 8 directed links with a routing matrix, H. Let yᵢ correspond to the fraction of probes on the path that arrive correctly at their destination. Also, let xᵢ correspond to the fraction of probes from all paths passing through link eᵢ that have not been dropped by that link. Given the network topology and end-to-end path loss rates, the linear relationship between the link loss rates and the path loss rates is established by Y=HX where Y={yᵢ}ᵢ₌₁⁶, and X={x₁}ᵢ₌₁⁸. Link loss rate vector, X, is determined by solving the under-determined linear system of equations, e.g., Equation 1.

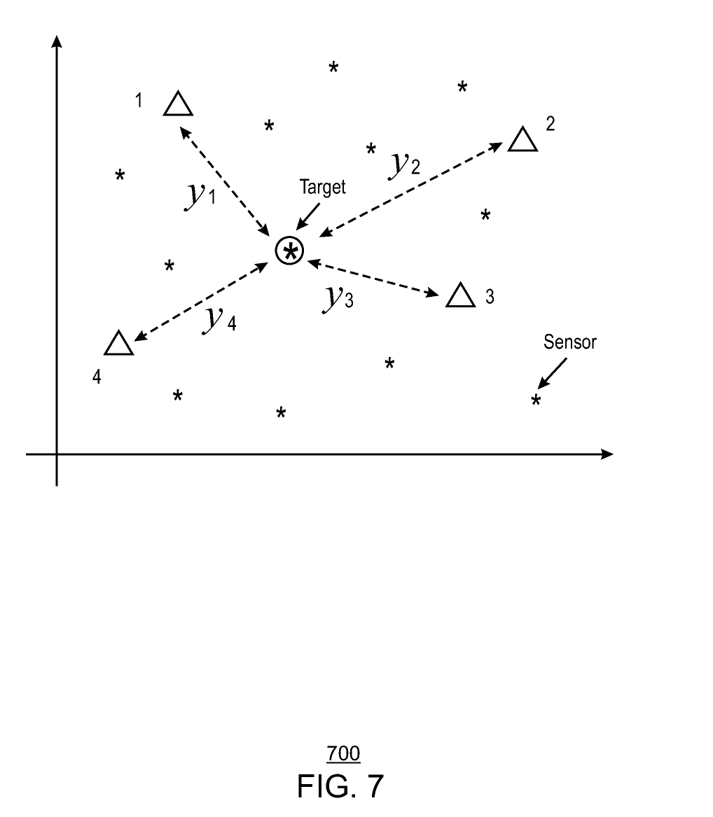

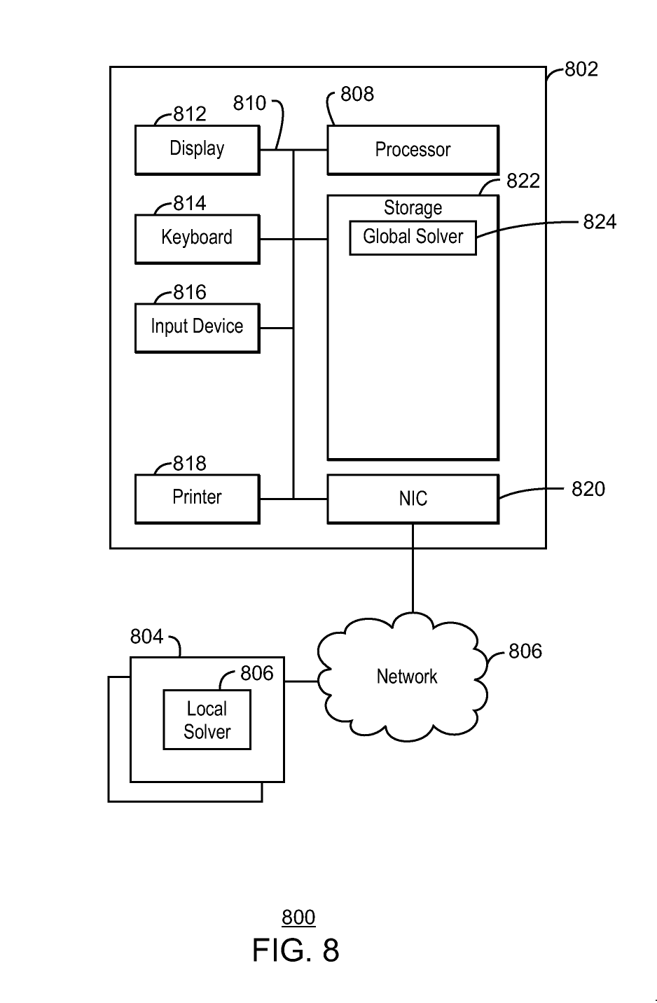

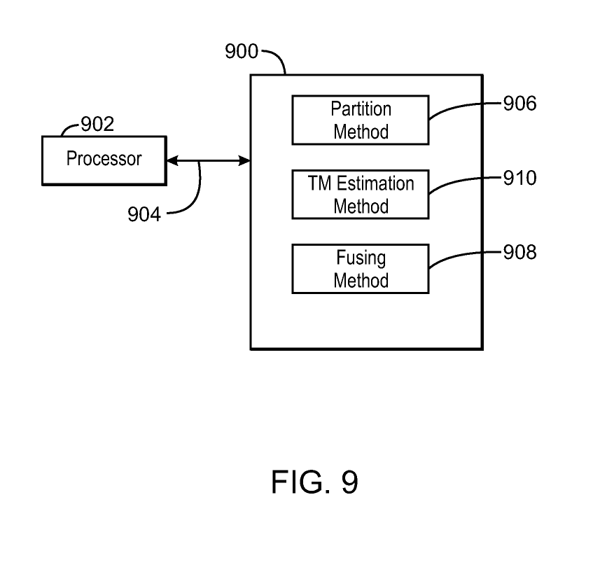

FIG. 7 is an example sensor network 700, in accordance with embodiments. In sensor network localization, a target sensor measures inconsistent signals as Received-Signal-Strength (RSS) or Time-of-Arrival (ToA) from anchor sensors with known locations, whereas target sensor locations are estimated. In the sensor network 700, the localization problem can be formulated as a sparse signal recovery from a small number of linear measurements, represented by an under-determined linear system of equations Y=HX. In this formulation, Y and X respectively denote the noisy observations (RSSs or ToAs) and unknown sensor's location, and H is the sensing matrix (demonstrating the linear relationship between Y and X). By solving this linear system of equations, sparse sensor location vector X can be estimated.

FIG. 8 is a block diagram of a system 800 for solving under-determined linear problems, in accordance with embodiments. The functional blocks and devices shown in FIG. 8 may comprise hardware elements, software elements, or some combination of software and hardware. The hardware elements may include circuitry. The software elements may include computer code stored as machine-readable instructions on a non-transitory, computer-readable medium. Additionally, the functional blocks and devices of the system 800 are but one example of functional blocks and devices that may be implemented in an example. Specific functional blocks may be defined based on design considerations for a particular electronic device.

The system 800 may represent the centralized system 400A, or the distributed system 400B, and includes a node 802, in communication with other nodes 804, over a network 806. The node 802 may include a processor 808, which may be connected through a bus 810 to a display 812, a keyboard 814, an input device 816, and an output device, such as a printer 818. The input devices 816 may include devices such as a mouse or touch screen. The server node 802 may also be connected through the bus 810 to a network interface card 820. The network interface card 820 may connect the server 802 to the network 806. The network 806 may be a local area network, a wide area network, such as the Internet, or another network configuration. The network 806 may include routers, switches, modems, or any other kind of interface device used for interconnection. In one example, the network 806 may be the Internet.

The node 802 may have other units operatively coupled to the processor 812 through the bus 810. These units may include non-transitory, computer-readable storage media, such as storage 822. The storage 822 may include media for the long-term storage of operating software and data, such as hard drives. The storage 822 may also include other types of non-transitory, computer-readable media, such as read-only memory and random access memory.

The storage 822 may include the machine readable instructions used in examples of the present techniques. In an example, the storage 822 may include a global solver 824. The global solver 824 may, in a centralized system, partition an under-determined problem into several sub-problems of a reduced order. The nodes 804 may each include a local solver 826 to solve one or more of the sub-problems, generating local solutions. The global solver 824 may fuse the local solutions to provide a global solution to the under-determined problem.

In a distributed system, the global solver 824 may determine a clustering of the nodes 804 to generate the local solutions. In such a system, the nodes 804 collect measurement statistics. The local solver 826 produces the local estimate, and fuses local estimates from the other nodes 804 to generate the global solution.

FIG. 9 is a block diagram showing a tangible, non-transitory, machine-readable medium that stores code adapted to solve under-determined linear problems, in accordance with embodiments. The machine-readable medium is generally referred to by the reference number 900. The machine-readable medium 900 may correspond to any typical storage device that stores computer-implemented instructions, such as programming code or the like. Moreover, the machine-readable medium 900 may be included in the storage 822 shown in FIG. 8.

When read and executed by a processor 902, the instructions stored on the machine-readable medium 900 are adapted to cause the processor 902 to solve an under-determined linear problem. The medium 900 includes partitioning method 906, a fusing method 908, and a traffic matrix estimation method 910.

The partitioning method 906 partitions an under-determined problem into several sub-problems of a reduced order. The traffic matrix estimation method 910 produces local solutions of the sub-problems, and the fusing method 908 fuses the local solutions to produce a global solution.

What is claimed is:

1. A method comprising:
partitioning an under-determined problem into a plurality of sub-problems of reduced order;
receiving a plurality of local solutions to the plurality of sub-problems; and
fusing the local solutions to generate a global solution to the under-determined problem.

2. The method recited by claim 1, wherein the under-determined problem is a traffic matrix estimation problem for a network.

3. The method recited by claim 2, comprising generating the plurality of local solutions using a specified traffic matrix estimation method.

4. The method recited by claim 1, wherein fusing the local solutions comprises:
generating a fusion function; and
applying the fusion function to the local solutions.

5. The method recited by claim 4, wherein the fusion function comprises averaging.

6. The method recited by claim 4, wherein the fusion function comprises selecting the local solutions with a highest inverse condition number (ICN).

7. The method recited by claim 4, wherein the fusion function comprises selecting the local solutions with a highest rank over origin-destination flow (ROD).

8. The method recited by claim 1, wherein partitioning the under-determined problem comprises selecting a plurality of sub-spaces comprising an associated plurality of highest inverse condition numbers.

9. The method recited by claim 1, wherein partitioning the under-determined problem comprises using a greedy algorithm that starts from a first row of a routing matrix for a network, and sequentially selects a plurality of rows that maximize an inverse condition number of a sub-matrix formed by a partition at each of the rows.

10. The method recited by claim 1, wherein partitioning the under-determined problem is based on a QR decomposition with pivoting of a routing matrix for the network.

11. The method recited by claim 1, wherein the plurality of local solutions are generated at a plurality of nodes comprising a plurality of largest degrees for a network, and wherein the under-determined problem is partitioned at local subspaces comprising the plurality of nodes.

12. The method recited by claim 1, wherein partitioning the under-determined problem comprises performing a column-wise partitioning, wherein a cross-correlation between origin-destinations flows are used.

13. The method recited by claim 1, wherein the under-determined problem comprises a network loss inference problem.

14. The method recited by claim 1, wherein the under-determined problem comprises a sensor network localization problem.

15. A computer system for performing traffic matrix estimation, the computer system comprising:
a processor that is adapted to execute stored instructions;
a network interface adapted to communicate with a network comprising the computer system; and
a memory device that stores instructions, the memory device comprising:
computer-implemented code adapted to receive measurement statistics for a plurality of local nodes in the network, wherein the local nodes comprise the computer system;
computer-implemented code adapted to generate a local traffic estimate for the local nodes;
computer-implemented code adapted to receive a plurality of local traffic estimates for a plurality of other nodes in the network;
computer-implemented code adapted to fuse the local traffic estimate for the local nodes, and the local traffic estimates for the other nodes, to generate a global solution for the traffic matrix estimation.

16. The computer system recited by claim 15, comprising computer-implemented code adapted to cluster a plurality of nodes in the network, wherein the plurality of nodes comprises the local nodes and the other nodes.

17. The computer system recited by claim 15, comprising computer-implemented code adapted to generate the local traffic estimate using a specified traffic matrix estimation method.

18. The computer system recited by claim 15, wherein the computer-implemented code adapted to fuse the local traffic estimate for the local nodes, and the local traffic estimates for the other nodes comprises:
generating a fusion function; and
applying the fusion function to the local traffic estimate for the local nodes, and the local traffic estimates for the other nodes.

19. A tangible, non-transitory, machine-readable medium that stores machine-readable instructions executable by a processor to solve a traffic matrix estimation problem for a network, the tangible, non-transitory, machine-readable medium comprising:
machine-readable instructions that, when executed by the processor, partition the traffic matrix estimation problem into a plurality of sub-problems of reduced order;
machine-readable instructions that, when executed by the processor, receive a plurality of local solutions to the sub-problems;
machine-readable instructions that, when executed by the processor, generate a fusion function that averages the local solutions; and
machine-readable instructions that, when executed by the processor, applies the fusion function to the local solutions, to generate a global solution to the traffic matrix estimation problem.

20. The tangible, machine-readable medium recited by claim 19, comprising machine-readable instructions that, when executed by the processor, generate the plurality of local solutions using a least squares error method.
